(19) United States
(12) Patent Application Publication
(10) Pub. No.: US 2026/0302060 A1
(43) Pub. Date: Oct. 1, 2026

(54) RARE EARTH MAGNET AND MANUFACTURING METHOD OF THE SAME

(71) Applicant: HONDA MOTOR CO., LTD., Tokyo (JP)

(72) Inventors: Akihito NINOMIYA, Saitama (JP); Yasutaka SHINTANI, Saitama (JP); Ibuki OTA, Saitama (JP)

(21) Appl. No.: 19/575,476

(22) Filed: Mar. 23, 2026

(30) Foreign Application Priority Data
Mar. 31, 2025 (JP) 2025-060068

(51) Int. Cl. H01F 41/02; B22F 1/068; B22F 1/16; B22F 3/14; H01F 1/057

(52) U.S. Cl. CPC H01F 41/0266; B22F 1/068; B22F 1/16; B22F 3/14; H01F 1/0572; H01F 1/0576; B22F 2301/355

(57) ABSTRACT

A manufacturing method of a rare earth magnet includes: a magnetic powder particle manufacturing step of manufacturing rare earth magnetic powder particles; an insulating layer forming step of forming an insulating layer on a surface layers of the rare earth magnetic powder particles to obtain insulated magnetic powder particles and insulated magnetic granular materials; a first primary molding step of primary molding, the insulated magnetic powder particles and insulated magnetic granular materials to obtain a first primary molded product; and a hot plastic working step of performing hot plastic working on the primary molded product to obtain the rare earth magnet. A major-axis length and an average thickness of the rare earth magnetic powder particles are adjusted such that the rare earth magnet has an electrical resistivity of 500 μΩcm or more and a squareness ratio of 70% or more.

### TECHNICAL FIELD

The present invention relates to a rare earth magnet and a manufacturing method of the rare earth magnet.

### BACKGROUND ART

In recent years, efforts have been actively made to realize a low-carbon or decarbonized society, and research and development of electrification technology is being conducted for vehicles to reduce CO₂ emissions and improve energy efficiency. Methods for improving energy efficiency include improving the efficiency of motors used as power sources. In recent years, rare earth magnets have been widely used to improve motor efficiency. There is a need to improve magnetic properties of rare earth magnets. Since rare earth magnets are metallic magnets having low electrical resistivity, eddy current loss is likely to increase. Therefore, technologies for reducing eddy current loss in rare earth magnets have been proposed.

JP4784173B discloses a rare earth magnet capable of reducing eddy current losses, having rare earth magnetic powder particles, each covered with a film-like coating layer containing rare earth oxides. Bond portions containing rare earth oxide particles are interposed between the magnet powder particles coated with the rare earth oxides. A method of producing the rare earth magnet comprises conducting high-temperature pressure forming of a mixture of rare earth oxides and rare earth magnetic powder particles coated with the rare earth oxides.

JP2003-22905A discloses a manufacturing method of a rare earth magnet, comprising: mixing a magnet powder particles composed mainly of an alloy containing a Nd₂Fe₁₄B compound with one or more insulating compounds selected from oxide such as CaO, nitride such as BN, or fluoride such as CaF₂ for the purpose of increasing the electrical resistivity of the rare earth magnet; and processing the resulting mixture by hot plastic working to obtain an anisotropic magnetic material.

JP2010-27852A discloses that a first manufacturing method of a rare earth magnet comprises: preparing isotropic rapid-cooled powder particles such as Nd-Fe-B magnet powder particles; mixing the isotropic rapid-cooled powder particles with a predetermined compound for forming insulating layers; processing the mixture by cold molding to produce a cold molded product (temporary molding); processing the cold molded product by hot molding (densifying); and processing, by hot plastic molding, the resultant product (imparting anisotropy) to produce the rare earth magnet, and that a so-produced magnet includes generally stacked Nd-Fe-B rapid-cooled powder particles with the compound powder material interposed between, each particle having a long side length of 100 to 400 μm and a thickness of 20 to 40 μm.

In the rare earth magnet described in JP4784173B, an insulating material composed of dysprosium oxide (Dy₂O₃) is used as the rare earth oxide. Since dysprosium oxide has hygroscopicity, moisture adsorbed onto the dysprosium oxide may reduce the magnetic properties of the rare earth magnet. In the manufacturing method of the rare earth magnet described in JP2003-22905A, in the mixing process of mixing the Nd-Fe-B magnet powder particles with the insulating compound, the magnet powder particle is pulverized and excessively subdivided, which increases a specific surface area of the magnet powder particle and makes the magnet powder particle more susceptible to oxidation. Accordingly, oxidation of the rare earth magnet may cause a reduction in magnetic flux density of the rare earth magnet.

In the manufacturing method of the rare earth magnet described in JP2010-27852A, compound A, which is at least one compound selected from the group consisting of fluorides, oxides, and inorganic salts of heavy rare earth elements, is reacted with compound B, which is a hydride of an alkaline earth metal, during the hot forming and heat treatment step. Here, side reactions such as oxidation of the magnet, or the reaction between compound A and compound B not proceeding appropriately may result in a reduction in the magnetic properties of the manufactured rare earth magnet. Accordingly, there is a demand for a material for a rare earth magnet having improved magnetic properties and a manufacturing method of a rare earth magnet having improved magnetic properties.

### SUMMARY OF THE INVENTION

In view of the above background, an object of the present invention is to provide a rare earth magnet having a suitable squareness ratio and reduced eddy current loss, and a manufacturing method of a rare earth magnet having a suitable squareness ratio and reduced eddy current loss, which consequently contributes to improving energy efficiency.

To achieve such an object, one aspect of the present invention provides a rare earth magnet, comprising: a plurality of laminated flake-shaped rare earth magnetic powder particles; and an insulating layer having insulating properties and provided on a surface layer of each of the plurality of rare earth magnetic powder particles. A major-axis length and an average thickness of the plurality of rare earth magnetic powder particles are adjusted such that the rare earth magnet has an electrical resistivity of 500 μΩcm or more and a squareness ratio of 70% or more.

According to this aspect, it is possible to provide the rare earth magnet which can have a suitable squareness ratio and reduced eddy current loss.

To achieve such an object, another aspect of the present invention provides a manufacturing method of a rare earth magnet, comprising: a magnetic powder particle manufacturing step of manufacturing a plurality of flake-shaped rare earth magnetic powder particles; a first insulating layer forming step of forming an insulating layer having insulating properties on a surface layer of each of the plurality of rare earth magnetic powder particles to obtain a plurality of insulated magnetic powder particles; a first primary molding step of primary molding, using a hot press, the plurality of insulated magnetic powder particles obtained in the first insulating layer forming step to obtain a first primary molded product in which the plurality of insulated magnetic powder particles is primarily molded; and a first hot plastic working step of performing hot plastic working on the first primary molded product obtained in the first primary molding step to obtain the rare earth magnet. A major-axis length and an average thickness of the plurality of rare earth magnetic powder particles are adjusted such that the rare earth magnet has an electrical resistivity of 500 μΩcm or more and a squareness ratio of 70% or more.

According to this aspect, it is possible to manufacture the rare earth magnet which can have a suitable squareness ratio and reduced eddy current loss.

To achieve such an object, another aspect of the present invention provides a manufacturing method of a rare earth magnet, comprising: a second binding step of manufacturing a plurality of magnetic granular materials, each of the plurality of magnetic granular materials including a plurality of laminated flake-shaped rare earth magnetic powder particles; a second insulating layer forming step of forming an insulating layer having insulating properties on a surface layer of each of the plurality of magnetic granular materials to obtain a plurality of insulated magnetic granular materials; a second primary molding step of primary molding, using a hot press, the plurality of insulated magnetic granular materials obtained in the second insulating layer forming step to obtain a second primary molded product in which the plurality of insulated magnetic granular materials is primarily molded; and a second hot plastic working step of performing hot plastic working on the second primary molded product obtained in the second primary molding step to obtain the rare earth magnet. A major-axis length and an average thickness of the plurality of rare earth magnetic powder particles are adjusted such that the rare earth magnet has an electrical resistivity of 500 μΩcm or more and a squareness ratio of 70% or more.

According to this aspect, it is possible to manufacture the rare earth magnet having a suitable squareness ratio and reduced eddy current loss.

Thus, according to the above aspects, it is possible to provide the rare earth magnetic powder particle and the insulated magnetic powder particle used as materials for the rare earth magnet having improved magnetic properties such as a residual magnetic flux density, and to provide a manufacturing method of a rare earth magnet having improved magnetic properties such as a residual magnetic flux density.

### BRIEF DESCRIPTION OF THE DRAWING(S)

FIG. 1 is a schematic cross-sectional view of a rare earth magnet according to a first embodiment of the present invention;

FIG. 2 is a diagram showing a manufacturing method of the rare earth magnet according to the first embodiment;

FIG. 3 is a schematic diagram of a tumbling fluidized bed apparatus;

FIG. 4 is a scanning electron micrograph (SEM) of a cross section of the rare earth magnet according to the first embodiment;

FIG. 5 is a schematic cross-sectional view of a rare earth magnet according to a second embodiment of the present invention; and

FIG. 6 is a diagram showing a manufacturing method of the rare earth magnet according to the second embodiment.

### DETAILED DESCRIPTION OF THE INVENTION

In the following, with reference to the drawings, a rare earth magnet 1 according to an embodiment of the present invention will be described in detail. In the following description, the numerical range "XX to YY" means "XX or more and YY or less" unless otherwise specified.

### First embodiment

### Structure of the rare earth magnet 1

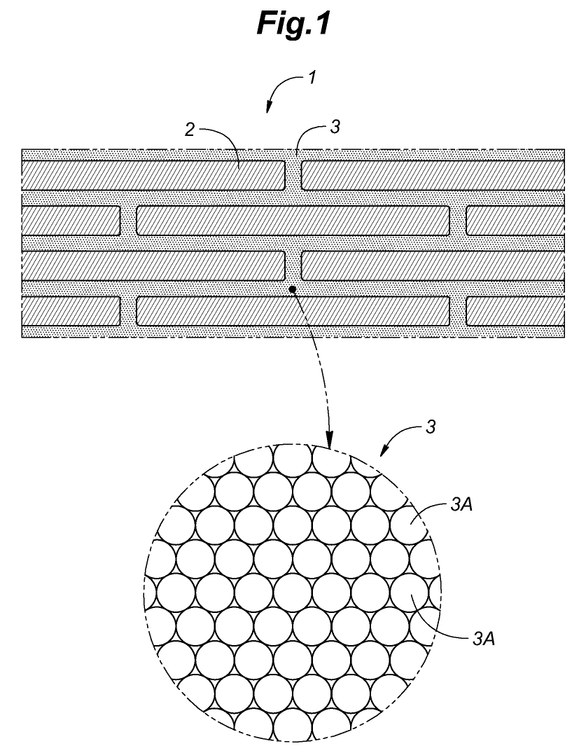

FIG. 1 is a schematic cross-sectional view of the rare earth magnet 1 according to the first embodiment. As shown in FIG. 1, the rare earth magnet 1 includes a plurality of rare earth magnetic powder particles 2 arranged so as to be laminated, and an insulating layer 3 having insulating properties and provided on a surface layer of the rare earth magnetic powder particles 2. The insulating layer 3 covers at least an outer peripheral surface of the rare earth magnetic powder particle 2. A major-axis length and an average thickness of the rare earth magnetic powder particles 2 are adjusted such that the rare earth magnet 1 has an electrical resistivity of 500 μΩcm or more and a squareness ratio of 70% or more.

The rare earth magnetic powder particle 2 is preferably a flake-shaped neodymium magnet (Nd-Fe-B magnet, more precisely Nd₂Fe₁₄B).

The insulating layer 3 includes a plurality of fluoride nanoparticles 3A made of a fluoride. The thickness of the insulating layer 3 is preferably 200 nm to 1,000 nm. The fluoride nanoparticles 3A may be particles made of calcium fluoride (CaF₂) and having a particle diameter of 1 to 100 nm. Calcium fluoride (CaF₂) has a melting point higher than that of the rare earth magnetic powder particles 2, and exhibits low reactivity with the rare earth magnetic powder particles 2. The fluoride nanoparticles 3A do not necessarily have a particle diameter of t1 o 100 nm.

The fluoride nanoparticles 3A may be particles made of an inorganic fluorine compound having insulating properties. The fluoride nanoparticles 3A preferably have a melting point higher than that of the rare earth magnetic powder particle 2 and exhibit low reactivity with the rare earth magnetic powder particles 2. Since the fluoride nanoparticles 3A have a melting point higher than that of the rare earth magnetic powder particle 2 and exhibit low reactivity with the rare earth magnetic powder particle 2, the fluoride nanoparticles 3A are preferably nanoparticles made of an alkali metal fluoride such as lithium fluoride, or nanoparticles made of an alkaline earth metal fluoride such as magnesium fluoride, barium fluoride, or strontium fluoride. The insulating layer 3 may include, as the fluoride nanoparticles 3A, a plurality of nanoparticles made of an alkali metal fluoride and a plurality of nanoparticles made of an alkaline earth metal fluoride. The insulating layer 3 may also include, as the fluoride nanoparticles 3A, nanoparticles containing an alkali metal fluoride and an alkaline earth metal fluoride.

Further, the insulating layer 3 may be the insulating layer 3 made of an alkali metal fluoride or an alkaline earth metal fluoride formed by sputtering. Even in this case, the thickness of the insulating layer 3 is preferably 200 nm to 1,000 nm.

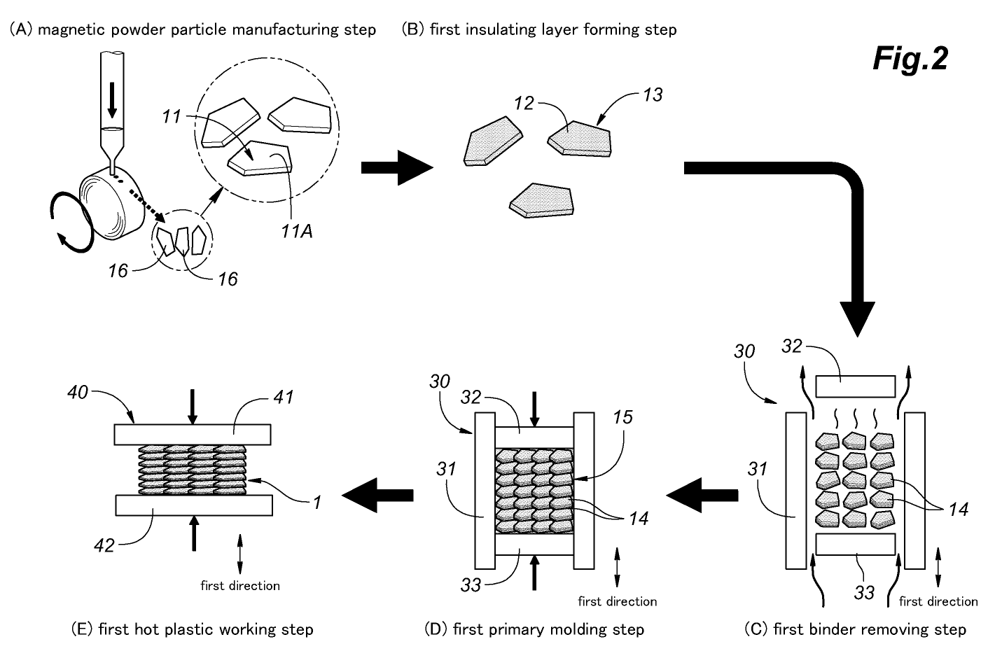

As will be described in detail later, in the manufacturing process of the rare earth magnet 1 (first hot plastic working step (E) of FIG. 2), the rare earth magnetic powder particles 2 are heated, while pressure is being applied thereto in a direction (first direction) perpendicular to a main surface thereof. Accordingly, crystal grains in the rare earth magnetic powder particle 2 (magnet) are shortened in the first direction (compression direction) and elongated in a direction perpendicular to the first direction (direction in which the main surface extends). That is, the crystal grains contained in the rare earth magnetic powder particle 2 have a length in a thickness direction of the rare earth magnetic powder particle 2 that is shorter than a length in a direction intersecting the thickness direction of the rare earth magnetic powder particle 2. The rare earth magnet 1 is magnetized in the first direction (compression direction). The crystal grains of the rare earth magnet 1 are oriented as described above, and the rare earth magnet 1 is magnetized as described above, which can increase the squareness ratio of the rare earth magnet 1.

### Manufacturing method of the rare earth magnet 1

FIG. 2 is a diagram showing the manufacturing method of the rare earth magnet 1. As shown in FIG. 2, the manufacturing method of the rare earth magnet 1 includes a magnetic powder particle manufacturing step (A) of manufacturing the rare earth magnetic powder particles 11, a first insulating layer forming step (B) of forming an insulating layer 12 on a surface of each of the rare earth magnetic powder particles 11 to obtain insulated magnetic powder particles 13, a first binder removing step (C) of removing the binder compound contained in the insulated magnetic powder particles 13 by thermal decomposition to obtain degreased magnetic powder particles 14, a first primary molding step (D) of primary molding the degreased magnetic powder particles 14 using a hot press to obtain a first primary molded product 15, and a first hot plastic working step (E) of performing hot plastic working on the first primary molded product 15 to obtain the rare earth magnet 1.

The magnetic powder particle manufacturing step (A) is a step of manufacturing the flake-shaped rare earth magnetic powder particles 11 having a predetermined size. A melt spinning technique is preferably used in the magnetic powder particle manufacturing step (A). As shown in step (A) of FIG. 2, the melt spinning technique is a technique of obtaining a thin plate-shaped magnet by spraying a rare earth magnet heated to a molten state onto a roll and cooling the sprayed rare earth magnet. The composition of the rare earth magnet to be melted is the same as the composition of the rare earth magnetic powder particle 2. The thin plate-shaped magnet is then pulverized to obtain small magnet pieces 16. Then, the rare earth magnetic powder particles 11 are obtained by classifying the rare earth magnetic powder particles 11 from the small magnet pieces 16. It should be noted that the melt spinning technique does not necessarily have to be used in the magnetic powder particle manufacturing step (A). The magnetic powder particle manufacturing step (A) may be a step of pulverizing a thin plate-shaped rare earth magnet to obtain the rare earth magnetic powder particles 11.

The composition of the rare earth magnetic powder particle 11 is the same as that of the rare earth magnetic powder particle 2. The rare earth magnetic powder particle 11 is a flake-shaped rare earth magnet. The rare earth magnetic powder particle 11 is preferably a flake-shaped neodymium magnet (Nd-Fe-B magnet, more precisely, Nd₂Fe₁₄B). The rare earth magnetic powder particles 11 have anisotropy, but may have isotropy. Anisotropy refers to a property in which crystal orientations (easy magnetization axes, c-axes) are aligned in a specific direction. Isotropy refers to a property in which crystal orientations are not aligned in a specific direction.

The rare earth magnetic powder particle 11 becomes more likely to crack as the thickness decreases. The lower limit of the major-axis length of the rare earth magnetic powder particle 11 is 300 μm, and the average thickness of the rare earth magnetic powder particles 11 is 10 μm to 30 μm. Further, the average thickness of the rare earth magnetic powder particles 11 is preferably 20 μm.

The rare earth magnetic powder particle 11 has a flake shape and includes a pair of main surfaces 11A. The main surfaces 11A are the largest pair of surfaces among a pair of flat surfaces facing opposite directions. The rare earth magnetic powder particle 11 may have an aspect ratio of approximately 1 (for example, 0.7 to 1.0) when viewed from a direction perpendicular to the main surfaces 11A. The aspect ratio is the ratio of the minor diameter b (minor-axis length) to a major diameter a (major-axis length) of a particle (aspect ratio = minor diameter b / major diameter a). Here, the major diameter a (major-axis length) means a maximum Feret diameter, and the minor diameter b (minor-axis length) means a minimum Feret diameter. The method for measuring the major diameter and the minor diameter complies with the provisions of JIS Z8890:2017 "Particle characterization of particulate systems."

The first insulating layer forming step (B) is a step of forming the insulating layer 12 having insulating properties on the surface layer of each of the rare earth magnetic powder particles 11 to obtain the insulated magnetic powder particles 13. The insulated magnetic powder particles 13 are powder particles obtained by forming the insulating layer 12 on the rare earth magnetic powder particles 11. It is preferable that the thickness of the insulating layer 12 be adjusted such that the insulating layer 3 of the rare earth magnet 1 has a thickness of 200 nm to 1,000 nm.

In the first insulating layer forming step (B), using the tumbling fluidized bed apparatus 20, a nanoparticle dispersion liquid containing the plurality of fluoride nanoparticles 3A is sprayed onto the rare earth magnetic powder particles 11 that are being tumbled and fluidized, thereby forming the insulating layer 12 on the surface layer of the rare earth magnetic powder particles 11. As described above, the fluoride nanoparticles 3A according to the present embodiment are made of calcium fluoride (CaF₂) and have a particle diameter of 1 to 100 nm.

The nanoparticle dispersion liquid contains, for example, 4 wt % of the fluoride nanoparticles 3A and 2.5 wt % of the binder compound. Accordingly, the insulating layer 12 formed by drying the nanoparticle dispersion liquid contains 38 wt % of the binder compound and 62 wt % of the fluoride nanoparticles 3A. The fluoride nanoparticles 3A are dispersed in the nanoparticle dispersion liquid. The concentrations of the fluoride nanoparticles 3A and the binder compound in the nanoparticle dispersion liquid, as well as the solvent, may be changed.

The binder compound is an acrylic polymer having a weight average molecular weight greater than 100,000 and not more than 300,000. The acrylic polymer is thermally decomposable at a temperature lower than the melting point of the rare earth magnetic powder particles 11. The binder compound may be any compound that can bind the fluoride nanoparticles 3A. The binder compound does not necessarily have a weight average molecular weight greater than 100,000 and not more than 300,000. The binder compound is not limited to an acrylic polymer. The binder compound is preferably a resin.

The solvent of the nanoparticle dispersion liquid is preferably 2-propanol (also referred to as "isopropyl alcohol" or "IPA"). The solvent of the binder compound solution is not limited to 2-propanol. The solvent of the binder compound solution is preferably alcohol. To allow the solvent to be readily evaporated after the rare earth magnetic powder particles 11 are bound so as to be laminated, the solvent of the binder compound solution is preferably a solvent that readily evaporates at room temperature.

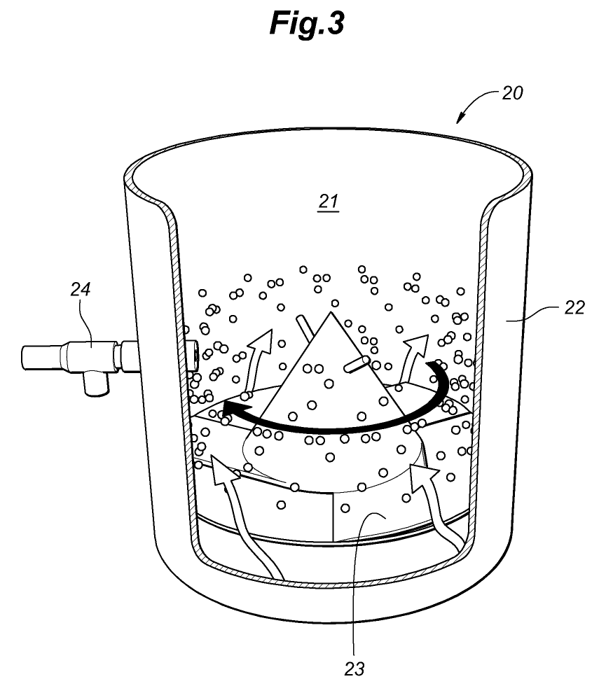

FIG. 3 is a schematic diagram of the tumbling fluidized bed apparatus 20. As shown in FIG. 3, the tumbling fluidized bed apparatus 20 includes a body housing 22 having a fluidized bed 21 therein for tumbling and fluidizing the rare earth magnetic powder particles 11, a rotatable blade rotor 23 that defines the bottom of the fluidized bed 21, a spray nozzle 24 provided on the side of the body housing 22, and an air blower (not shown) that transmits a swirling air flow to the fluidized bed 21 through a gap between the outer circumference of the blade rotor 23 and the body housing 22. The spray nozzle 24 is attached to the body housing 22 to spray the binder compound solution toward the lower portion of the fluidized bed 21.

In the first insulating layer forming step (B), as shown in FIG. 3, the rare earth magnetic powder particles 11 are introduced into the fluidized bed 21 of the tumbling fluidized bed apparatus 20. The blade rotor 23 is then rotated, and the air blower generates a swirling air flow within the fluidized bed 21. As a result, the rare earth magnetic powder particles 11 in the fluidized bed 21 are tumbled and fluidized. In this state, the nanoparticle dispersion liquid is sprayed from the spray nozzle 24 onto the rare earth magnetic powder particles 11 that are being tumbled and fluidized. The sprayed nanoparticle dispersion liquid adheres to the surfaces of the rare earth magnetic powder particles 11 and is dried. Accordingly, the insulating layer 12 is formed on the surface layers of the rare earth magnetic powder particles 11, and the insulated magnetic powder particles 13 are obtained.

The first insulating layer forming step (B) may include forming the insulating layer 12 made of an alkali metal fluoride or an alkaline earth metal fluoride on the rare earth magnetic powder particles 11 by sputtering.

The first binder removing step (C) is a step of heating the insulated magnetic powder particles 13 to a temperature equal to or higher than the thermal decomposition temperature of the binder compound to thermally decompose the binder compound, thereby obtaining the degreased magnetic powder particles 14 from which the binder compound has been removed.

In the first binder removing step (C), the insulated magnetic powder particles 13 may be heated within the mold of a hot press machine. As shown in step (C) of FIG. 2, a mold 30 of the hot press machine includes a cylindrical mold body 31, an upper mold 32 and a lower mold 33 capable of applying a compressive force in a first direction to an object within the mold body 31. In FIG. 2, the first direction is the up-and-down direction, but the first direction may be a direction other than the up-and-down direction.

In the first binder removing step (C), the insulated magnetic powder particles 13 arranged within the mold body 31 of the mold 30 are heated, without pressure being applied by the mold 30 (the upper mold 32 and the lower mold 33), to a temperature equal to or higher than the thermal decomposition temperature of the binder compound (for example, 300°C to 400°C) for the predetermined period (for example, 2 to 4 hours) in a reduced pressure environment or in an inert gas flow. The inert gas is a gas having low reactivity with the rare earth magnetic powder particles 11. The inert gas is preferably, for example, a noble gas. The inert gas is preferably helium gas. Air may be used instead of the inert gas.

The products generated by thermal decomposition of the binder compound are discharged to the outside of the mold 30. The binder compound is preferably an acrylic polymer (polymethyl methacrylate) having a weight average molecular weight greater than 100,000 and not more than 300,000. The acrylic polymer is thermally decomposed into the methyl methacrylate monomer. The decomposition products generated by the thermal decomposition of the binder compound volatilize and are discharged to the outside of the mold 30.

When the insulated magnetic powder particles 13 are heated in the reduced pressure environment in the first binder removing step (C), the insulated magnetic powder particles 13 are heated within the mold body 31 (the mold 30) in the reduced pressure environment. When the insulated magnetic powder particles 13 are heated in an inert gas flow, the insulated magnetic powder particles 13 are heated while the inert gas is flowing inside the mold body 31 (the mold 30). This allows the decomposition products of the binder compound (for example, the methyl methacrylate monomer) to readily volatilize and be discharged to the outside of the mold body 31 (the mold 30) when placed in the reduced pressure environment or in the inert gas flow. Further, the decomposition products of the binder compound are less likely to remain around the insulated magnetic powder particles 13 and less likely to react with the rare earth magnetic powder particle 11, thereby suppressing deterioration of the rare earth magnetic powder particle 11. It is preferable that the inert gas be heated to a temperature equal to or higher than the thermal decomposition temperature of the binder compound before the inert gas is introduced into the mold 30. This allows the binder compound to be heated by the inert gas, thereby promoting the thermal decomposition of the binder compound.

The first primary molding step (D) is a step of primary molding, using a hot press, the degreased magnetic powder particles 14 to obtain the first primary molded product 15. The mold 30 may be used in the first primary molding step (D). The first primary molding step (D) is a step of primary molding, using a hot press, the degreased magnetic powder particles 14 obtained by removing the binder compound from the insulated magnetic powder particles 13 to obtain the first primary molded product 15.

The first primary molding step (D) may be a step of performing hot forming (primary molding) in which the degreased magnetic powder particles 14 are heated to the predetermined temperature within the mold 30, and the predetermined pressure is applied for the predetermined period. Here, hot forming may be performed at a mold temperature of 600°C to 700°C, preferably about 640°C. When pressure is applied to the degreased magnetic powder particles 14 within the mold 30, the plurality of degreased magnetic powder particles 14 are oriented so that the main surfaces 11A of the rare earth magnetic powder particles 11 contained in the degreased magnetic powder particles 14 face the first direction, and are laminated in a direction (the first direction) perpendicular to the main surfaces 11A. Accordingly, by hot forming, the plurality of degreased magnetic powder particles 14 are compressed and deformed while being laminated in a direction (the first direction) perpendicular to the main surfaces of the degreased magnetic powder particles 14 (the main surfaces 11A of the rare earth magnetic powder particles 11).

The first hot plastic working step (E) is a step of performing hot plastic working on the first primary molded product 15 obtained in the first primary molding step (D) to obtain the rare earth magnet 1. The first hot plastic working step (E) includes heating the first primary molded product 15, while applying pressure thereto, to a temperature at which a part of the crystal grains of the rare earth magnetic powder particles 11 undergoes a phase transition to a liquid phase (melting point of the rare earth magnetic powder particles 11, for example, about 850°C) thereby plastically deforming the first primary molded product 15.

The first hot plastic working step (E) is performed using a second mold 40. The second mold 40 has an upper pressing die 41 and a lower pressing die 42 arranged opposite to each other. The first primary molded product 15 is arranged within the second mold 40 such that pressure is applied to the plurality of degreased magnetic powder particles 14 contained in the first primary molded product 15 in a direction (first direction) perpendicular to the main surfaces. During plastic deformation of the first primary molded product 15, the crystal grains of the rare earth magnetic powder particles 11 contained in the first primary molded product 15 are oriented such that a c-axis direction (an easy magnetization direction) of the crystal grains is parallel to the first direction (the compression direction). Accordingly, magnetic anisotropy (uniaxial anisotropy) is developed in the first primary molded product 15 during the plastic deformation. The rare earth magnetic powder particles 2 contained in the rare earth magnet 1 are obtained by plastically deforming the rare earth magnetic powder particles 11 such that the crystal grains are oriented in the first direction (the compression direction). The rare earth magnet 1 obtained in the first hot plastic working step (see FIG. 1) is magnetized in the direction (first direction) in which the magnetic anisotropy is developed.

In the first hot plastic working step (E), the degreased magnetic powder particles 14 are heated, while pressure is being applied thereto in a direction (first direction) perpendicular to the main surfaces of the degreased magnetic powder particles 14. Accordingly, the crystal grains in the magnet are shortened in the first direction (the compression direction) and elongated in a direction perpendicular to the first direction (the direction in which the main surface extends). That is, the crystal grains contained in the rare earth magnetic powder particle 2 have a length in a thickness direction (the compression direction) of the rare earth magnetic powder particle 2 that is shorter than a length in a direction intersecting the thickness direction of the rare earth magnetic powder particle 2. The rare earth magnet 1 is magnetized in the first direction (the compression direction). The crystal grains of the rare earth magnet 1 are oriented as described above, and the rare earth magnet 1 is magnetized as described above, thereby increasing the squareness ratio of the rare earth magnet 1.

As shown in FIG. 1, the rare earth magnet 1 is an aggregate of the rare earth magnetic powder particles 2 each having the insulating layer 3 on the surface layer thereof, and has high electrical resistivity due to the insulating layer 3. This reduces the eddy current loss of the rare earth magnet 1. Accordingly, the rare earth magnet 1 has a suitable squareness ratio and reduced eddy current loss.

Next, the effects of the rare earth magnet 1 manufactured in this manner and the manufacturing method thereof will be described.

The major-axis length and the average thickness of the plurality of rare earth magnetic powder particles 2 are adjusted such that the rare earth magnet 1 has the electrical resistivity of 500 μΩcm or more and the squareness ratio of 70% or more. This allows the rare earth magnet 1 to achieve a suitable squareness ratio and reduced eddy current loss.

The insulating layer 3 includes the plurality of fluoride nanoparticles 3A made of an alkali metal fluoride or an alkaline earth metal fluoride and having a particle diameter of 1 to 100 nm. This appropriately ensures the insulating property of the insulating layer 3. Accordingly, the insulating layer 3 can reliably increase the electrical resistivity of the rare earth magnet 1 and reliably reduce the eddy current loss of the rare earth magnet 1.

The insulating layer 3 has a thickness of 200 nm to 1,000 nm. This appropriately ensures the insulating property of the insulating layer 3. Further, the insulating layer 3 can reliably increase the electrical resistivity of the rare earth magnet 1 and reliably reduce the eddy current loss of the rare earth magnet 1.

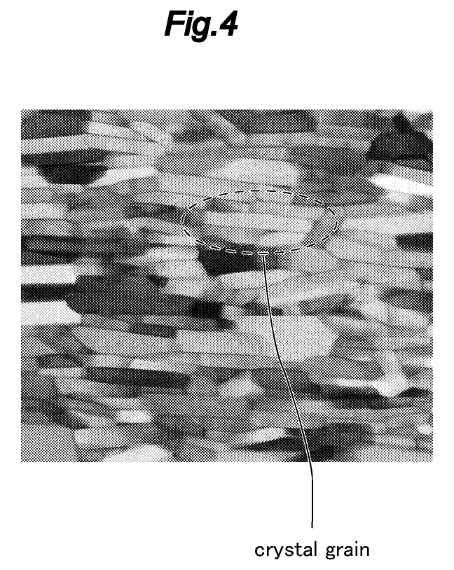

FIG. 4 is a scanning electron micrograph (SEM) of a cross section of the rare earth magnet 1. As shown in FIG. 4, the crystal grains contained in the rare earth magnetic powder particles 2 have a length in the thickness direction of the rare earth magnetic powder particles 2 that is shorter than the length in a direction intersecting the thickness direction of the rare earth magnetic powder particles 2. This is believed to contribute to an increase in the squareness ratio of the rare earth magnet 1.

The manufacturing method of the rare earth magnet 1 includes the first hot plastic working step (E) of performing hot plastic working on the first primary molded product 15 obtained in the first primary molding step (D) to obtain the rare earth magnet 1. The major-axis length and the average thickness of the plurality of rare earth magnetic powder particles 11 are adjusted such that the rare earth magnet 1 has an electrical resistivity of 500 μΩcm or more and a squareness ratio of 70% or more. Accordingly, it is possible to manufacture the rare earth magnet 1 having a suitable squareness ratio and reduced eddy current loss.

The first insulating layer forming step (B) includes forming the insulating layer 12 made of an alkali metal fluoride or an alkaline earth metal fluoride by sputtering, or forming the insulating layer 12 by binding the plurality of fluoride nanoparticles 3A to the surface layer of each of the rare earth magnetic powder particles 11, the plurality of fluoride nanoparticles 3A being made of an alkali metal fluoride or an alkaline earth metal fluoride and having a particle diameter of 1 to 100 nm. This appropriately ensures the insulating property of the insulating layer 3 of the rare earth magnet 1, thereby reliably increasing the electrical resistivity of the rare earth magnet 1 and reliably reducing eddy current loss of the rare earth magnet 1.

### Second embodiment

### Structure of a rare earth magnet 51

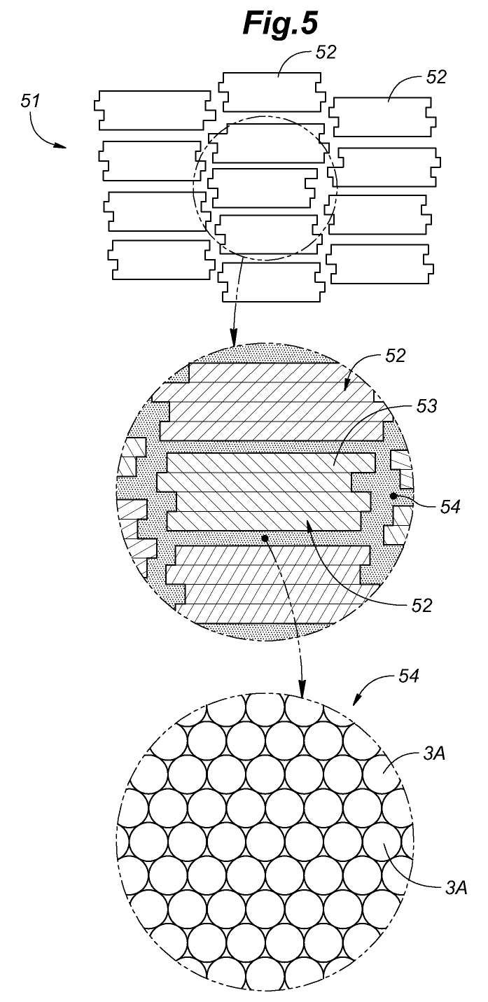

FIG. 5 is a schematic cross-sectional view of the rare earth magnet 51 according to a second embodiment of the present invention. As shown in FIG. 5, the rare earth magnet 51 includes a plurality of insulated magnetic granular materials 52 arranged so as to be laminated. The insulated magnetic granular material 52 includes a plurality of laminated flake-shaped rare earth magnetic powder particles 53 and an insulating layer 54 formed on a surface layer of the insulated magnetic granular material 52 and having insulating properties. The insulating layer 54 covers an outer peripheral surface of the laminated rare earth magnetic powder particles 53.

The rare earth magnetic powder particle 53 is a flake-shaped rare earth magnetic powder particle 53 similar to the rare earth magnetic powder particle 2 of the first embodiment. The insulating layer 54 is similar to the insulating layer 3 of the first embodiment. The insulating layer 54 includes, similarly to the insulating layer 3 of the first embodiment, the plurality of fluoride nanoparticles 3A made of a fluoride. The fluoride nanoparticles 3A are particles made of calcium fluoride (CaF₂). The particle diameter of the fluoride nanoparticles 3A is preferably 1 to 100 nm.

Further, the insulating layer 54 may be the insulating layer 54 made of an alkali metal fluoride or an alkaline earth metal fluoride formed by sputtering. Even in this case, the thickness of the insulating layer 54 is preferably 200 nm to 1,000 nm.

### Manufacturing method of the rare earth magnet 51

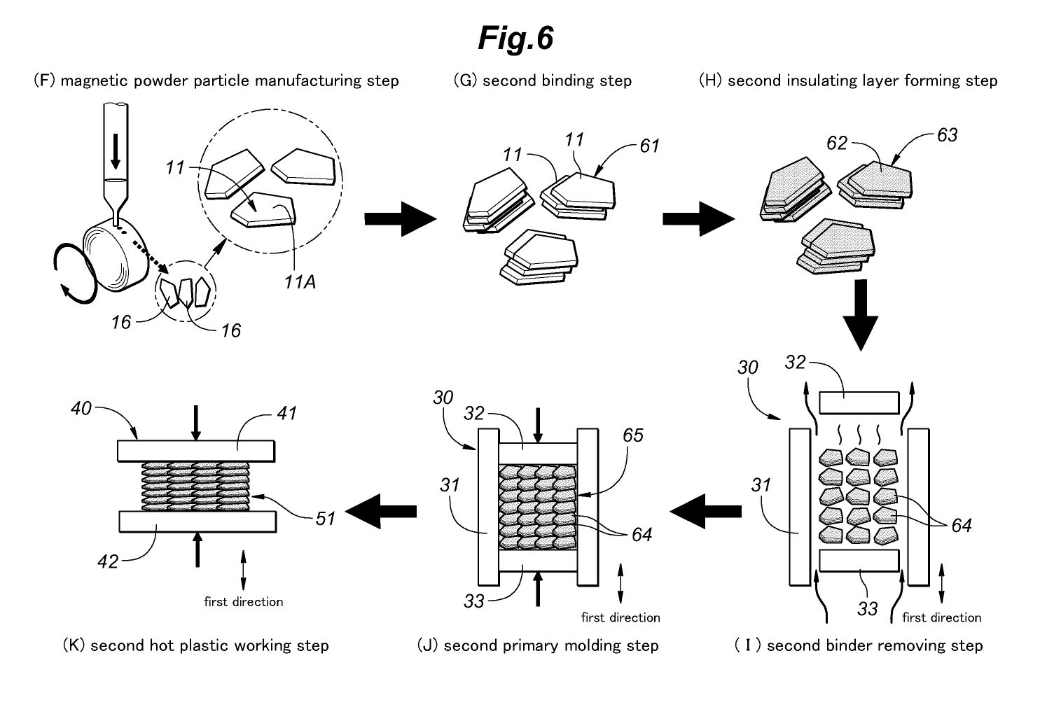

FIG. 6 is a diagram showing a manufacturing method of the rare earth magnet 51. As shown in FIG. 6, the manufacturing method of the rare earth magnet 51 includes a magnetic powder particle manufacturing step (F) of manufacturing the rare earth magnetic powder particles 11, a second binding step (G) of binding the rare earth magnetic powder particles 11 so as to be laminated to obtain the magnetic granular material 61, the second insulating layer forming step (H) of forming an insulating layer 62 on a surface of each of the magnetic granular materials 61 to obtain insulated magnetic granular materials 63, a second binder removing step (I) of removing the binder compound contained in the insulated magnetic granular materials 63 by thermal decomposition to obtain degreased magnetic granular materials 64, a second primary molding step (J) of primary molding the degreased magnetic granular materials 64 to obtain the second primary molded product 65, and a second hot plastic working step (K) of performing hot plastic working on the second primary molded product 65 to obtain the rare earth magnet 51.

Since the magnetic powder particle manufacturing step (F) is similar to the magnetic powder particle manufacturing step (A) in the manufacturing method of the rare earth magnet 1 according to the first embodiment shown in FIG. 2, the description thereof will be omitted.

The second binding step (G) is a step of binding the plurality of rare earth magnetic powder particles 11 so as to be laminated by the binder compound to obtain the magnetic granular material 61. In the second binding step, the binder compound solution may be sprayed onto the rare earth magnetic powder particles 11 that are being tumbled and fluidized using the tumbling fluidized bed apparatus 20 (see FIG. 3), and the plurality of rare earth magnetic powder particles 11 is bound so as to be laminated by the binder compound.

The binder compound solution is, for example, a solution containing 4 wt % of the binder compound. The solvent of the binder compound solution is preferably 2-propanol (IPA), but is not limited thereto. The solvent of the binder compound solution is preferably alcohol. To allow the solvent to be readily evaporated after the rare earth magnetic powder particles 11 are bound so as to be laminated, the solvent of the binder compound solution is preferably a solvent that readily evaporates at room temperature.

As shown in FIG. 3, in the second binding step (G), the rare earth magnetic powder particles 11 are introduced into the fluidized bed 21. The blade rotor 23 is then rotated, and the air blower generates a swirling air flow within the fluidized bed 21. As a result, the rare earth magnetic powder particles 11 in the fluidized bed 21 are tumbled and fluidized. In this state, the binder compound solution is sprayed from the spray nozzle 24 onto the rare earth magnetic powder particles 11 that are being tumbled and fluidized. Here, to properly bind the rare earth magnetic powder particles 11, the binder compound solution is preferably sprayed at a rate of not less than 5 g/min and not more than 30 g/min per 1 kg of the rare earth magnetic powder particles 11 that are being tumbled and fluidized.

The rare earth magnetic powder particles 11 are bound by the sprayed binder compound solution. Here, the binder compound solution binds the main surfaces 11A of the adjacent rare earth magnetic powder particles 11. The solvent (IPA) evaporates from the binder compound solution that binds the rare earth magnetic powder particles 11. Accordingly, the magnetic granular material 61 is obtained in which the plurality of rare earth magnetic powder particles 11 is bound so as to be laminated by the binder compound. Here, the phrase “being bound so as to be laminated” means that a plurality of rare earth magnetic powder particles 11 are bound with the main surfaces 11A thereof facing in the same direction. The magnetic granular material 61 includes the plurality of laminated flake-shaped rare earth magnetic powder particles 11. The term "laminated flake-shaped rare earth magnetic powder particles 11" means a plurality of rare earth magnetic powder particles 11 laminated with the main surfaces 11A thereof facing the same direction.

In the magnetic granular material 61, the binder compound solution that binds the rare earth magnetic powder particles 11 is dried. The magnetic granular material 61 preferably contains 0.5 to 2.5 wt % of the binder compound. The concentration of the binder compound in the binder compound solution and the injection amount of the binder compound solution are set so that the magnetic granular material 61 contains 0.5 to 2.5 wt % of the binder compound. In order for the rare earth magnet 1 manufactured from the magnetic granular material 61 to have suitable magnetic properties, the thickness of the magnetic granular material 61 in the lamination direction is preferably 0. 15 mm or more and 1 mm or less.

As shown in FIG. 6, the second insulating layer forming step (H) is a step of forming the insulating layer 62 having insulating properties on the surface layer of each of the magnetic granular materials 61 to obtain the insulated magnetic granular materials 63. The insulated magnetic granular material 63 is a granular material obtained by forming the insulating layer 62 on the magnetic granular material 61. In the second insulating layer forming step (H), using the tumbling fluidized bed apparatus 20, the nanoparticle dispersion liquid containing the plurality of fluoride nanoparticles 3A is sprayed onto the magnetic granular materials 61 that are being tumbled and fluidized, thereby forming the insulating layer 62 on the surface layer of the magnetic granular materials 61. As described above, the fluoride nanoparticles 3A according to the present embodiment are nanoparticles made of calcium fluoride (CaF₂) and have a particle diameter of 1 to 100 nm.

The nanoparticle dispersion liquid contains, for example, 4 wt % of the fluoride nanoparticles 3A and 2.5 wt % of the binder compound. Accordingly, the insulating layer 62 formed by drying the nanoparticle dispersion liquid contains 38 wt % of the binder compound and 62 wt % of the fluoride nanoparticles 3A.

The solvent of the nanoparticle dispersion liquid is preferably 2-propanol (IPA). The binder compound is a compound capable of binding the fluoride nanoparticles 3A, and is preferably the same compound as the binder compound used in the second binding step (G). The fluoride nanoparticles 3A are dispersed in the nanoparticle dispersion liquid. The concentrations of the fluoride nanoparticles 3A and the binder compound in the nanoparticle dispersion liquid, as well as the solvent, may be changed.

In the second insulating layer forming step (H), as shown in FIG. 3, the magnetic granular materials 61 are introduced into the fluidized bed 21 of the tumbling fluidized bed apparatus 20. The blade rotor 23 is then rotated, and the air blower generates a swirling air flow within the fluidized bed 21. As a result, the magnetic granular materials 61 in the fluidized bed 21 are tumbled and fluidized. In this state, the nanoparticle dispersion liquid is sprayed from the spray nozzle 24 onto the magnetic granular materials 61 that are being tumbled and fluidized. The sprayed nanoparticle dispersion liquid adheres to the surfaces of the magnetic granular materials 61 and is dried. Accordingly, the insulating layer 62 is formed on the surface layers of the magnetic granular materials 61, and the insulated magnetic granular materials 63 are obtained.

The insulating layer 62 formed as described above preferably contains the plurality of fluoride nanoparticles 3A made of a fluoride and having a particle diameter of 1 to 100 nm, and is formed to contain 20 wt % or more of the binder compound that binds the plurality of fluoride nanoparticles 3A.

The second binder removing step (I) is a step of heating the insulated magnetic granular materials 63 to a temperature equal to or higher than the thermal decomposition temperature of the binder compound to thermally decompose the binder compound, thereby obtaining the degreased magnetic granular materials 64 from which the binder compound has been removed. The second binder removing step (I) is similar to the first binder removing step (C) in the manufacturing method of the rare earth magnet 1 according to the first embodiment shown in FIG. 2. In second binder removing step (I), similarly to the first binder removing step (C), the insulated magnetic granular materials 63 arranged within the mold body 31 of the mold 30 are heated, without pressure being applied by the mold 30 (the upper mold 32 and the lower mold 33), to a temperature equal to or higher than the thermal decomposition temperature of the binder compound (for example, 300°C to 400°C) for the predetermined period (for example, 2 hours to 4 hours) in a reduced pressure environment or in an inert gas flow.

The second primary molding step (J) is a step of primarily molding, using a hot press, the degreased magnetic granular materials 64 to obtain the second primary molded product 65 in which the degreased magnetic granular materials 64 are primarily molded. The second primary molding step (J) may be considered as one type of step in which the plurality of insulated magnetic granular materials 63 obtained in the second insulating layer forming step (H) is primarily molded, using a hot press, to obtain the second primary molded product 65 in which the plurality of insulated magnetic granular materials 63 is primarily molded.

The second primary molding step (J) is similar to the first primary molding step (D) in the manufacturing method of the rare earth magnet 1 according to the first embodiment shown in FIG. 2.

The second primary molding step (J) may be a step of performing hot forming (primary molding) in which the degreased magnetic granular materials 64 are heated to the predetermined temperature within the mold 30, and the predetermined pressure is applied for the predetermined period, similarly to the first primary molding step (D). In the second primary molding step (J), by hot forming, the plurality of degreased magnetic granular materials 64 is compressed and deformed while being laminated in a direction (the first direction) perpendicular to the main surfaces of the degreased magnetic granular materials 64 (the main surfaces 11A of the rare earth magnetic powder particles 11).

The second hot plastic working step (K) is a step of performing hot plastic working on the second primary molded product 65 obtained in the second primary molding step (J) to obtain the rare earth magnet 51. The second hot plastic working step (K) is similar to the first hot plastic working step (E) in the manufacturing method of the rare earth magnet 1 according to the first embodiment shown in FIG. 2. The second hot plastic working step (K) includes heating the second primary molded product 65, while applying pressure thereto, to a temperature at which a part of the crystal grains of the rare earth magnetic powder particles 11 undergoes a phase transition to a liquid phase (melting point of the rare earth magnetic powder particles 11, for example, about 850°C), thereby plastically deforming the second primary molded product 65.

In the second hot plastic working step (K), pressure is applied to the plurality of degreased magnetic granular materials 64 contained in the second primary molded product 65 in a direction (first direction) perpendicular to the main surfaces. During plastic deformation of the second primary molded product 65, the crystal grains of the rare earth magnetic powder particles 11 contained in the second primary molded product 65 are oriented such that the c-axis direction (the easy magnetization direction) of the crystal grains is parallel to the first direction (the compression direction). Accordingly, magnetic anisotropy (uniaxial anisotropy) is developed in the second primary molded product 65 during the plastic deformation. The rare earth magnetic powder particles 53 contained in the rare earth magnet 51 are obtained by plastically deforming the rare earth magnetic powder particles 11 such that the crystal grains are oriented in the first direction (the compression direction). The rare earth magnet 51 obtained in the second hot plastic working step (K) (see FIG. 5) is magnetized in the direction (first direction) in which the anisotropy is developed.

In the second hot plastic working step (K), the degreased magnetic granular materials 64 are heated, while pressure is being applied thereto in a direction (first direction) perpendicular to the main surfaces of the degreased magnetic granular materials 64. Accordingly, the crystal grains in the magnet are shortened in the first direction (the compression direction) and elongated in a direction perpendicular to the first direction (the direction in which the main surface extends). Further, after the second hot plastic working step (K), the rare earth magnet 51 is magnetized in the first direction (the compression direction). The crystal grains of the rare earth magnet 51 are oriented as described above, and the rare earth magnet 51 is magnetized as described above, which can increase the squareness ratio of the rare earth magnet 51.

As shown in FIG. 5, the rare earth magnet 51 is an aggregate of the insulated magnetic granular materials 52 each having the insulating layer 54 as the surface layer thereof, and has high electrical resistivity due to the insulating layer 54. This reduces the eddy current loss of the rare earth magnet 51. Accordingly, the rare earth magnet 51 has a suitable squareness ratio and reduced eddy current loss.

Next, the effects of the rare earth magnet 51 manufactured in this manner and the manufacturing method thereof will be described.

The major-axis length and the average thickness of the plurality of rare earth magnetic powder particles 53 are adjusted such that the rare earth magnet 51 has the electrical resistivity of 500 μΩcm or more and the squareness ratio of 70% or more. Accordingly, the rare earth magnet 51 has a suitable squareness ratio and reduced eddy current loss.

The crystal grains contained in the rare earth magnetic powder particles 53 have a length in the thickness direction of the rare earth magnetic powder particles 53 that is shorter than the length in the direction intersecting the thickness direction of the rare earth magnetic powder particle 53. This increases the squareness ratio of the rare earth magnet 51.

The manufacturing method of the rare earth magnet 51 includes the second hot plastic working step (K) of performing hot plastic working on the second primary molded product 65 obtained in the second primary molding step (J) to obtain the rare earth magnet 51. The major-axis length and the average thickness of the plurality of rare earth magnetic powder particles 11 are adjusted such that the rare earth magnet 51 has the electrical resistivity of 500 μΩcm or more and the squareness ratio of 70% or more. Accordingly, it is possible to manufacture the rare earth magnet 51 having a suitable squareness ratio and reduced eddy current loss.

The second insulating layer forming step (H) includes forming the insulating layer 62 by sputtering, or forming the insulating layer 62 by binding the plurality of fluoride nanoparticles 3A to the surface layer of each of the magnetic granular materials 61, the plurality of fluoride nanoparticles 3A being made of an alkali metal fluoride or an alkaline earth metal fluoride and having a particle diameter of 1 to 100 nm. This appropriately ensures the insulating property of the insulating layer 54 of the rare earth magnet 51, thereby reliably increasing the electrical resistivity of the rare earth magnet 51 and reliably reducing eddy current loss of the rare earth magnet 51.

The above embodiments may also be described as follows:

One embodiment provides a rare earth magnet 1, 51, comprising: a plurality of laminated flake-shaped rare earth magnetic powder particles 2, 53; and an insulating layer 3, 54 having insulating properties and provided on a surface layer of each of the plurality of rare earth magnetic powder particles 2, 53. A major-axis length and an average thickness of the plurality of rare earth magnetic powder particles 2, 53 are adjusted such that the rare earth magnet 1, 51 has an electrical resistivity of 500 μΩcm or more and a squareness ratio of 70% or more.

According to this aspect, it is possible to provide the rare earth magnets 1, 51 having a suitable squareness ratio and reduced eddy current loss.

In one embodiment, the insulating layer 3, 54 includes a plurality of fluoride nanoparticles 3A made of a fluoride and having a particle diameter of 1 to 100 nm, and the fluoride is an alkali metal fluoride or an alkaline earth metal fluoride.

According to this aspect, the insulating layer 3, 54 can reliably increase the electrical resistivity of the rare earth magnet 1 and reliably reduce the eddy current loss of the rare earth magnet 1.

In one embodiment, the insulating layer 3, 54 has a thickness of 200 nm to 1,000 nm.

According to this aspect, the insulating properties of the insulating layer 3, 54 are properly ensured. Accordingly, the insulating layer 3 can reliably increase the electrical resistivity of the rare earth magnet 1 and reliably reduce the eddy current loss of the rare earth magnet 1.

In one embodiment, in the rare earth magnet 1, 51, crystal grains contained in each of the plurality of rare earth magnetic powder particles 2, 53 have a length in a thickness direction of the plurality of rare earth magnetic powder particles 2, 53 that is shorter than a length in a direction intersecting the thickness direction of the plurality of rare earth magnetic powder particles 2, 53.

According to this aspect, the squareness ratio of the rare earth magnet 1, 51 can be increased.

Another embodiment provides a manufacturing method of a rare earth magnet 1, comprising: a magnetic powder particle manufacturing step (A) of manufacturing a plurality of flake-shaped rare earth magnetic powder particles 11; a first insulating layer forming step (B) of forming an insulating layer 12 having insulating properties on a surface layer of each of the plurality of rare earth magnetic powder particles 11 to obtain a plurality of insulated magnetic powder particles 13; a first primary molding step (D) of primary molding, using a hot press, the plurality of insulated magnetic powder particles 13 obtained in the first insulating layer forming step (B) to obtain a first primary molded product 15 in which the plurality of insulated magnetic powder particles 13 is primarily molded; and a first hot plastic working step (E) of performing hot plastic working on the first primary molded product 15 obtained in the first primary molding step (D) to obtain the rare earth magnet 1. A major-axis length and an average thickness of the plurality of rare earth magnetic powder particles 11 are adjusted such that the rare earth magnet 1 has an electrical resistivity of 500 μΩcm or more and a squareness ratio of 70% or more.

According to this aspect, it is possible to manufacture the rare earth magnet 1 having a suitable squareness ratio and reduced eddy current loss.

One embodiment is the manufacturing method of the rare earth magnet 1, in which the first insulating layer forming step (B) includes forming the insulating layer 12 made of an alkali metal fluoride or an alkaline earth metal fluoride by sputtering, or forming the insulating layer 12 by binding a plurality of fluoride nanoparticles 3A to the surface layer of each of the plurality of rare earth magnetic powder particles 11, the plurality of fluoride nanoparticles 3A being made of an alkali metal fluoride or an alkaline earth metal fluoride and having a particle diameter of 1 to 100 nm.

According to this aspect, the insulating property of the insulating layer 3 of the rare earth magnet 1 is reliably ensured, thereby reliably increasing the electrical resistivity of the rare earth magnet 1 and reliably reducing eddy current loss of the rare earth magnet 1.

Another embodiment provides a manufacturing method of a rare earth magnet 1, comprising: a second binding step (F) of manufacturing a plurality of magnetic granular materials 61, each of the plurality of magnetic granular materials 61 including a plurality of laminated flake-shaped rare earth magnetic powder particles 11; a second insulating layer forming step (H) of forming an insulating layer 62 having insulating properties on a surface layer of each of the plurality of magnetic granular materials 61 to obtain a plurality of insulated magnetic granular materials 63; a second primary molding step (J) of primary molding, using a hot press, the plurality of insulated magnetic granular materials 63 obtained in the second insulating layer forming step (H) to obtain a second primary molded product 65 in which the plurality of insulated magnetic granular materials 63 is primarily molded; and a second hot plastic working step (K) of performing hot plastic working on the second primary molded product 65 obtained in the second primary molding step (J) to obtain the rare earth magnet 51. A major-axis length and an average thickness of the plurality of rare earth magnetic powder particles 11 are adjusted such that the rare earth magnet 51 has an electrical resistivity of 500 μΩcm or more and a squareness ratio of 70% or more.

According to this aspect, it is possible to manufacture the rare earth magnet 51 having a suitable squareness ratio and reduced eddy current loss.

One embodiment is the manufacturing method of the rare earth magnet 1, in which the second insulating layer forming step (H) includes forming the insulating layer 62 by sputtering, or forming the insulating layer 62 by binding a plurality of fluoride nanoparticles 3A to the surface layer of each of the magnetic granular materials 61, the plurality of fluoride nanoparticles 3A being made of an alkali metal fluoride or an alkaline earth metal fluoride and having a particle diameter of 1 to 100 nm.

According to this aspect, the insulating property of the insulating layer 54 of the rare earth magnet 51 is reliably ensured, thereby reliably increasing the electrical resistivity of the rare earth magnet 51 and reliably reducing eddy current loss of the rare earth magnet 51.

This concludes the description of the specific embodiment, but the present invention is not limited to the above embodiments and can be widely modified and implemented. For example, the solvent of the binder compound solution and the nanoparticle dispersion liquid is not limited to IPA, and may be an alcohol that is liquid at room temperature, such as 1-propanol or butanol.

1. A rare earth magnet, comprising:
a plurality of laminated flake-shaped rare earth magnetic powder particles; and
an insulating layer having insulating properties and provided on a surface layer of each of the plurality of rare earth magnetic powder particles, wherein
a major-axis length and an average thickness of the plurality of rare earth magnetic powder particles are adjusted such that the rare earth magnet has an electrical resistivity of 500 μΩcm or more and a squareness ratio of 70% or more.

2. The rare earth magnet according to claim 1, wherein
the insulating layer includes a plurality of fluoride nanoparticles made of a fluoride and having a particle diameter of 1 to 100 nm, and
the fluoride is an alkali metal fluoride or an alkaline earth metal fluoride.

3. The rare earth magnet according to claim 1, wherein the insulating layer has a thickness of 200 nm to 1,000 nm.

4. The rare earth magnet according to claim 1, wherein crystal grains contained in each of the plurality of rare earth magnetic powder particles have a length in a thickness direction of the plurality of rare earth magnetic powder particles that is shorter than a length in a direction intersecting the thickness direction of the plurality of rare earth magnetic powder particles.

5. A manufacturing method of a rare earth magnet, comprising:
a magnetic powder particle manufacturing step of manufacturing a plurality of flake-shaped rare earth magnetic powder particles;
a first insulating layer forming step of forming an insulating layer having insulating properties on a surface layer of each of the plurality of rare earth magnetic powder particles to obtain a plurality of insulated magnetic powder particles;
a first primary molding step of primary molding, using a hot press, the plurality of insulated magnetic powder particles obtained in the first insulating layer forming step to obtain a first primary molded product in which the plurality of insulated magnetic powder particles is primarily molded; and
a first hot plastic working step of performing hot plastic working on the first primary molded product obtained in the first primary molding step to obtain the rare earth magnet, wherein
a major-axis length and an average thickness of the plurality of rare earth magnetic powder particles are adjusted such that the rare earth magnet has an electrical resistivity of 500 μΩcm or more and a squareness ratio of 70% or more.

6. The manufacturing method of the rare earth magnet according to claim 5, wherein the first insulating layer forming step includes forming the insulating layer made of an alkali metal fluoride or an alkaline earth metal fluoride by sputtering, or forming the insulating layer by binding a plurality of fluoride nanoparticles to the surface layer of each of the plurality of rare earth magnetic powder particles, the plurality of fluoride nanoparticles being made of an alkali metal fluoride or an alkaline earth metal fluoride and having a particle diameter of 1 to 100 nm.

7. A manufacturing method of a rare earth magnet, comprising:
a second binding step of manufacturing a plurality of magnetic granular materials, each of the plurality of magnetic granular materials including a plurality of laminated flake-shaped rare earth magnetic powder particles;
a second insulating layer forming step of forming an insulating layer having insulating properties on a surface layer of each of the plurality of magnetic granular materials to obtain a plurality of insulated magnetic granular materials;
a second primary molding step of primary molding, using a hot press, the plurality of insulated magnetic granular materials obtained in the second insulating layer forming step to obtain a second primary molded product in which the plurality of insulated magnetic granular materials is primarily molded; and
a second hot plastic working step of performing hot plastic working on the second primary molded product obtained in the second primary molding step to obtain the rare earth magnet, wherein
a major-axis length and an average thickness of the plurality of rare earth magnetic powder particles are adjusted such that the rare earth magnet has an electrical resistivity of 500 μΩcm or more and a squareness ratio of 70% or more.

8. The manufacturing method of the rare earth magnet according to claim 7, wherein the second insulating layer forming step includes forming the insulating layer by sputtering, or forming the insulating layer by binding a plurality of fluoride nanoparticles to the surface layer of each of the plurality of magnetic granular materials, the plurality of fluoride nanoparticles being made of an alkali metal fluoride or an alkaline earth metal fluoride and having a particle diameter of 1 to 100 nm.
